(19) United States
(12) Patent Application Publication
(10) Pub. No.: US 2026/0118817 A1
(43) Pub. Date: Apr. 30, 2026

(54) IMAGE FORMING APPARATUS

(71) Applicant: KYOCERA Document Solutions Inc., Osaka (JP)

(72) Inventor: Hiroki MORISHITA, Osaka (JP)

(73) Assignee: KYOCERA Document Solutions Inc., Osaka (JP)

(21) Appl. No.: 19/361,296

(22) Filed: Oct. 17, 2025

(30) Foreign Application Priority Data
Oct. 25, 2024 (JP) 2024-188061

(51) Int. Cl. G03G 21/16

(52) U.S. Cl. CPC G03G 21/1647; G03G 21/1619; G03G 2221/1606; G03G 2221/163; G03G 2221/1636; G03G 2221/1654; G03G 2221/1678

(57) ABSTRACT

An image forming apparatus includes a body frame, a drum unit, and an exposure unit. The drum unit is inserted to between a pair of side plates through an opening. The body frame includes a fitted plate. The drum unit is fitted to, in a state positioned with respect to, the fitted plate. The exposure unit is fitted to, in a state positioned with respect to, a stay. One side plate has a through hole. The stay has a positioning protrusion. The fitted plate has a positioning hole. Inserting the positioning projection that projects outward from the one side plate through the through hole into the positioning hole positions the stay and the fitted plate with respect to each other.

### INCORPORATION BY REFERENCE

This application is based on and claims the benefit of priority from Japanese Patent Application No. 2024-188061 filed on Oct. 25, 2024, the contents of which are hereby incorporated by reference.

### BACKGROUND

The present disclosure relates to an image forming apparatus.

Conventional image forming apparatuses include a drum unit. The drum unit includes a photosensitive drum and the like. The drum unit is removably mounted in the body of an image forming apparatus.

During image formation, through an exposure process by an exposure unit, an electrostatic latent image is formed on the outer circumferential surface of the photosensitive drum. The electrostatic latent image is developed into a toner image. Then the toner image is primarily transferred to an intermediate transfer belt and is secondarily transferred from the intermediate transfer belt to a sheet.

Here, the exposure unit is a unit that is separate from the drum unit. Thus, if the drum unit is not mounted in the apparatus body accurately, the drum unit is displaced with respect to the exposure unit. This causes a displacement of the position at which the electrostatic latent image starts to be formed on the photosensitive drum, and leads to an image defect.

### SUMMARY

According to one aspect of the present disclosure, an image forming apparatus includes a body frame, a drum unit, and an exposure unit. The body frame includes a pair of side plates facing each other along a predetermined direction and a stay disposed between the pair of side plates along the predetermined direction. The drum unit is disposed between the pair of side plates along the predetermined direction and includes a photosensitive drum. The exposure unit is disposed between the pair of side plates along the predetermined direction and shines light to the outer circumferential surface of the photosensitive drum to form an electrostatic latent image on the outer circumferential surface of the photosensitive drum. One side plate of the pair of side plates has an opening penetrating it along the predetermined direction. The drum unit is disposed between the pair of side plates along the predetermined direction by being inserted from outward of the one side plate along the predetermined direction through the opening to between the pair of side plates along the predetermined direction. The body frame further includes a fitted plate that covers the opening from outward along the predetermined direction. The drum unit is fitted to, in a state positioned with respect to, the fitted plate. The exposure unit is fitted to, in a state positioned with respect to, the stay. The one side plate has a through hole penetrating it along the predetermined direction. The stay has a positioning projection that projects outward along the predetermined direction from the one side plate via the through hole. The fitted plate has a positioning hole penetrating it along the predetermined direction. Inserting the positioning projection that projects outward along the predetermined direction from the one side plate through the through hole into the positioning hole positions the stay and the fitted plate.

### BRIEF DESCRIPTION OF THE DRAWINGS

FIG. 1 is a perspective view of an image forming apparatus according to an embodiment.

FIG. 2 is a schematic diagram showing the internal configuration of the image forming apparatus according to the embodiment.

FIG. 3 is a perspective view of drum units according to the embodiment.

FIG. 4 is a perspective view of an exposure unit according to the embodiment.

FIG. 5 is a perspective view of development units according to the embodiment.

FIG. 6 is a perspective view of a body frame according to the embodiment.

FIG. 7 is a perspective view of a right side plate in the body frame according to the embodiment.

FIG. 8 is a perspective view of a front stay in the body frame according to the embodiment.

FIG. 9 is a perspective view of a rear stay in the body frame according to the embodiment.

FIG. 10 is a perspective view (as seen from outward) of a part for positioning between the stays and the right side plate in the body frame according to the embodiment.

FIG. 11 is a perspective view (as seen from inward) of a part for positioning between the stays and the right side plate in the body frame according to the embodiment.

FIG. 12 is a perspective view illustrating how the exposure unit is fitted to the body frame according to the embodiment.

FIG. 13 is a perspective view illustrating how the drum units are fitted to the body frame according to the embodiment.

FIG. 14 is a perspective view illustrating how the development units are fitted to the body frame according to the embodiment.

FIG. 15 is a perspective view showing a state where a fitted plate is fitted to the right side plate in the body frame according to the embodiment.

FIG. 16 is a perspective view of the fitted plate for the body frame according to the embodiment.

FIG. 17 is a perspective view of a part for positioning between the fitted plate and the front stay in the body frame according to the embodiment.

FIG. 18 is a perspective view of a part for positioning between the fitted plate and the rear stay in the body frame according to the embodiment.

FIG. 19 is an enlarged perspective view of and around a positioning portion of the drum unit according to the embodiment.

FIG. 20 is an enlarged perspective view of and around a positioning portion of the development unit according to the embodiment.

### DETAILED DESCRIPTION

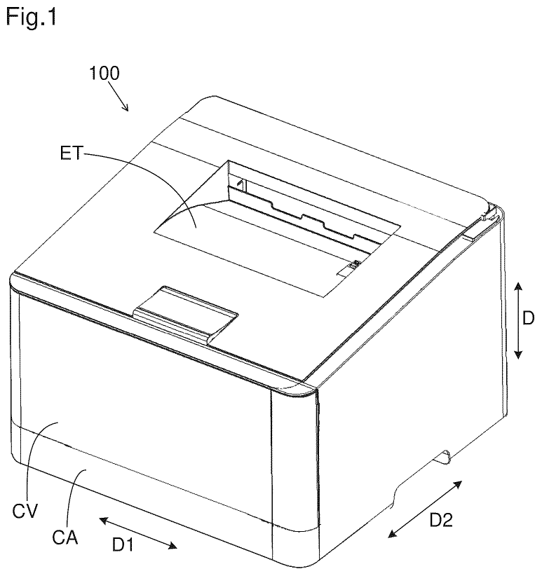

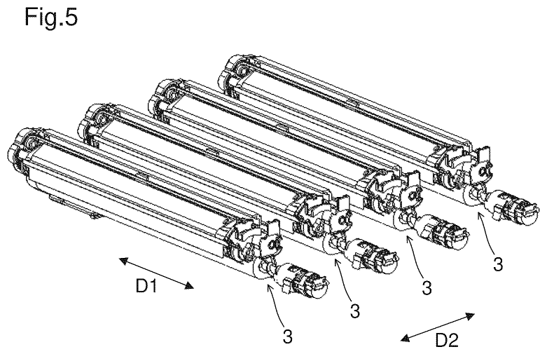

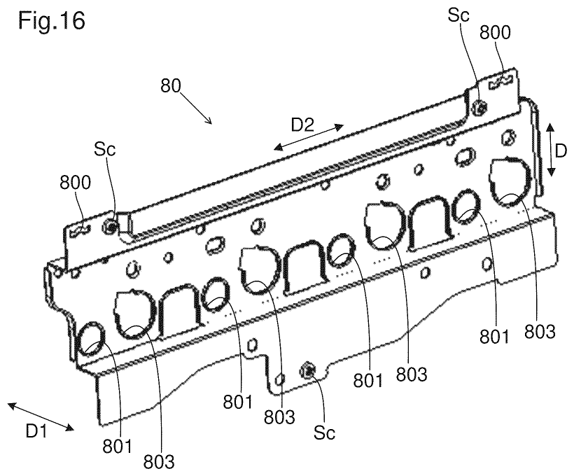

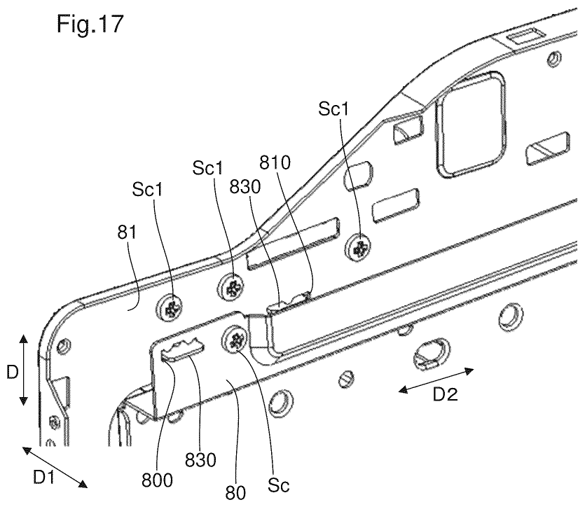

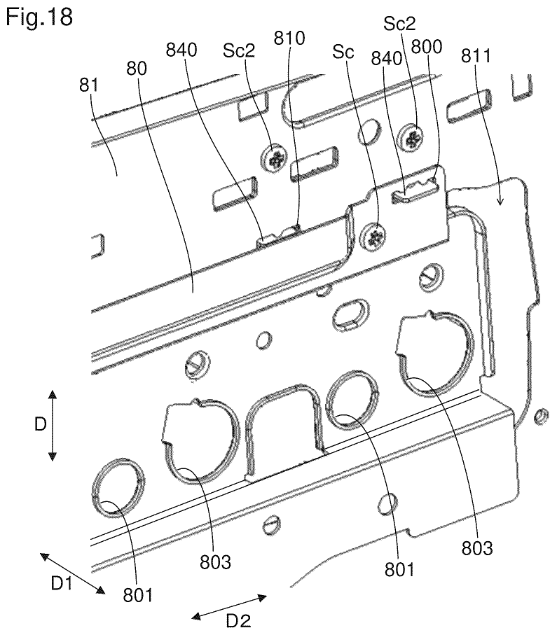

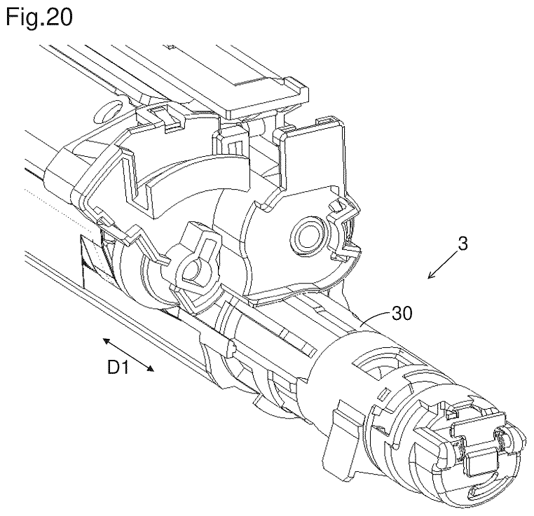

With reference to FIGS. 1 to 20, an image forming apparatus 100 according to one embodiment of the present disclosure will be described below. While the description below takes as an example a color laser printer of a tandem type, this is not meant as any limitation: what is disclosed herein is applicable equally to multifunctional peripherals having copying and other functions.

In the following description, the direction that is perpendicular to a flat floor surface on which the image forming apparatus 100 is installed is defined as the top-bottom direction D. Note that the top-bottom direction D is a vertical direction. In addition, among horizontal directions that are orthogonal to the top-bottom direction D, one is defined as the left-right direction D1 and another that is perpendicular to that direction is defined as the front-rear direction D2. The left-right direction D1 corresponds to a “predetermined direction.”

### Overall Configuration of Image Forming Apparatus

The image forming apparatus 100 according to the embodiment has an exterior appearance as shown in FIG. 1. The exterior appearance of the image forming apparatus 100 shown in FIG. 1 is merely an example and is not meant as any limitation.

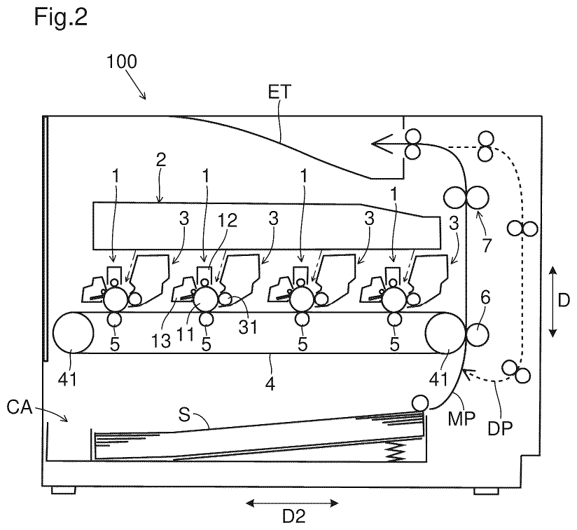

As shown in FIG. 2, the image forming apparatus 100 includes a main conveyance passage MP. In FIG. 2, the main conveyance passage MP is indicated by a solid-line arrow. A duplex printing conveyance passage DP, which will be described later, is indicated by a broken-line arrow.

The image forming apparatus 100 includes a sheet cassette CA. The sheet cassette CA stores sheets S used in a print job. There is no particular limitation on the type of sheet S.

In a print job, a sheet S in the sheet cassette CA is fed to the main conveyance passage MP. The image forming apparatus 100 conveys the sheet S along the main conveyance passage MP. Then, the image forming apparatus 100 prints an image on the sheet S being conveyed. In other words, the image forming apparatus 100 transfers a toner image to the sheet S being conveyed.

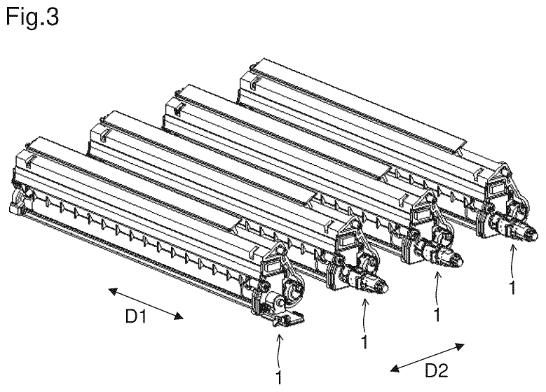

The image forming apparatus 100 includes a drum unit 1. Four drum units 1 are assigned to different colors, namely cyan, magenta, yellow, and black. The exterior appearances of the drum units 1 are shown in FIG. 3.

Each of the drum units 1 has a photosensitive drum 11, a charging device 12, a drum cleaning device 13, and the like. Rotary members such as the photosensitive drums 11 in the drum units 1 are supported so as to be rotatable about axes extending along the left-right direction D1. The drum units 1 are fitted to, in a state positioned with respect to, a body frame 8, which will be described later.

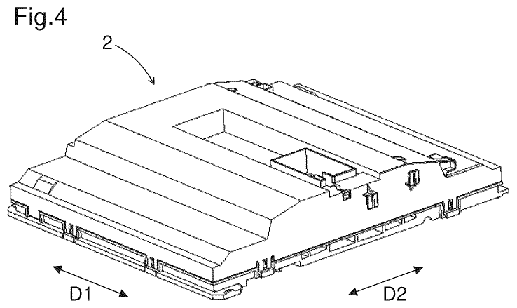

The image forming apparatus 100 includes an exposure unit 2. One exposure unit 2 is provided and is shared for all the colors. The exterior appearance of the exposure unit 2 is shown in FIG. 4. The exposure unit 2 is fitted to, in a state positioned with respect to, the body frame 8, which will be described later.

The image forming apparatus 100 includes a development unit 3. Four development units 3 are assigned to the different colors, namely cyan, magenta, yellow, and black. In other words, the development units 3 are assigned to the different drum units 1. Each of the development unit 3 has a development roller 31 and the like. Rotary members such as the development rollers 31 in the development units 3 are supported so as to be rotatable about axes extending along the left-right direction D1. The development units 3 are fitted to, in a state positioned with respect to, the body frame 8, which will be described later.

A print job proceeds as follows. The photosensitive drums 11 rotate. The charging devices 12 electrostatically charge the outer circumferential surfaces of the corresponding photosensitive drums 11. The exposure unit 2 shines light to the outer circumferential surfaces of the photosensitive drums 11 to form electrostatic latent images on the outer circumferential surfaces of the photosensitive drums 11. The development units 3 feed toner to the electrostatic latent images on the outer circumferential surfaces of the corresponding photosensitive drums 11 to develop the electrostatic latent images into toner images. The drum cleaning devices 13 clean the outer circumferential surfaces of the corresponding photosensitive drums 11.

The image forming apparatus 100 further includes an intermediate transfer belt 4. The intermediate transfer belt 4 is an endless belt. The intermediate transfer belt 4 is in contact with the outer circumferential surfaces of the photosensitive drums 11. The intermediate transfer belt 4 is stretched around a plurality of stretching rollers 41. The stretching rollers 41 are supported so as to be rotatable about axes extending along the left-right direction D1. As the stretching rollers 41 rotate, the intermediate transfer belt 4 rotates (is driven).

The image forming apparatus 100 includes a primary transfer roller 5. Four primary transfer rollers 5 are assigned to the different colors, namely cyan, magenta, yellow, and black. The primary transfer rollers 5 are disposed on the inner circumference side of the intermediate transfer belt 4. Between the primary transfer rollers 5 and the photosensitive drums 11 carrying the toner images of the corresponding colors, the intermediate transfer roller 4 is disposed. The primary transfer rollers 5 are supported so as to be rotatable about axes extending along the left-right direction D1.

The image forming apparatus 100 includes a secondary transfer roller 6. The secondary transfer roller 6 is in contact with the outer circumferential surface of the intermediate transfer belt 4. The secondary transfer roller 6 forms a transfer nip with the intermediate transfer belt 4. The secondary transfer roller 6 is supported so as to be rotatable about an axis extending along the left-right direction D1.

As the print job proceeds, a sheet S is conveyed from the sheet cassette CA toward the transfer nip. On the other hand, toner images are primarily transferred from the photosensitive drums 11 to the outer circumferential surface of the intermediate transfer belt 4. Thus, while the sheet S is passing through the transfer nip, the toner images are secondarily transferred to the sheet S.

The image forming apparatus 100 includes a fixing unit 7. The fixing unit 7 includes a heating roller and a pressing roller. The heating roller incorporates a heater. The pressing roller is in pressed contact with the heating roller. The heating roller and the pressing roller are in pressed contact with each other to form a fixing nip downstream the transfer nip in the sheet conveyance direction.

As the print job proceeds, the sheet S passes through the fixing nip. At that time, the sheet S is heated and pressed. This fixes the toner images to the sheet S. Then, the sheet S is discharged onto a discharge tray ET.

The image forming apparatus 100 can perform, as a print job, not only a simplex print job in which printing is performed on only one side of the sheet S but also a duplex print job in which printing is performed on both sides of the sheet S. For the duplex print job, the image forming apparatus 100 includes a duplex printing conveyance passage DP.

The duplex printing conveyance passage DP branches off the main conveyance passage MP at a position along it downstream of the fixing nip in the sheet conveyance direction. Then, the duplex printing conveyance passage DP joins the main conveyance passage MP at a position along it upstream of the transfer nip in the sheet conveyance direction.

If the job being performed is a simplex printing, the sheet S passes through the transfer nip only once and a transferring process is performed once on the sheet S passing through the transfer nip. Then, when the first-time transferring is complete, the sheet S is discharged as it is onto the discharge tray ET.

If the job being performed is a duplex print job, the sheet S passes through the transfer nip twice so that a transferring process is performed once on each of the front and back sides of the sheet S. Specifically, when the sheet S passes through the transfer nip for the first time, a transferring process is performed on one side of the sheet S. When the first-time transferring process is complete, after the trailing edge of the sheet S has passed through the fixing nip, before the sheet S is completely discharged onto the discharge tray ET, the sheet S is switched back. Thus, the sheet S is, starting with its trailing edge, pulled into the duplex printing conveyance passage DP.

After that, the sheet S is conveyed along the duplex printing conveyance passage DP. The sheet S in the duplex printing conveyance passage DP is then returned to the main conveyance passage MP. The sheet S passes through the transfer nip once again. At that time, the front and back sides of the sheet S are reversed as compared with when it passed through the transfer nip for the first time. Thus, when the sheet S passes through the transfer nip for the second time, a transferring process is performed on the other side of the sheet S, that is, the side opposite from the one side.

### Configuration of Body Frame

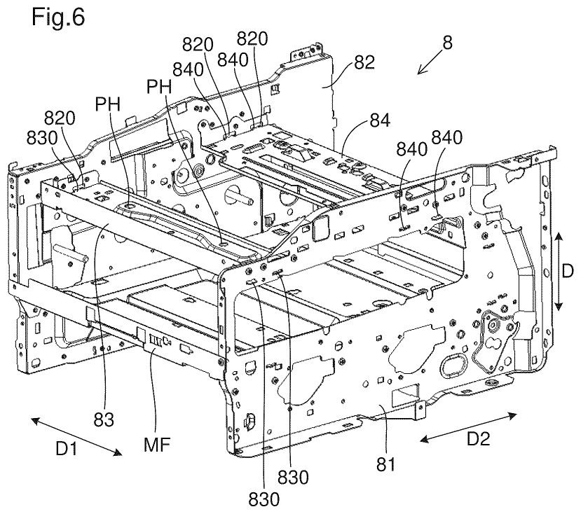

The image forming apparatus 100 includes a body frame 8 as shown in FIG. 6. The members constituting the body frame 8 are made of metal and can be formed by working on metal sheets. The body frame 8 is covered with an exterior cover CV (see FIG. 1). The body frame 8 is fitted with different members constituting the image forming apparatus 100.

The body frame 8 includes a pair of side plates 81 and 82. The pair of side plates 81 and 82 face each other along the left-right direction D1. The pair of side plates 81 and 82 are disposed at an interval from each other along the left-right direction D1. The pair of side plates 81 and 82 each have a part of which the plate thickness direction aligns with the left-right direction D1. As seen from one side along the front-rear direction D2 (i.e., from the front, or obverse, side of the image forming apparatus 100), the side plate 81 is disposed at the right side (one side along the left-right direction D1) and the side plate 82 is disposed at the left side (the other side along the left-right direction D1).

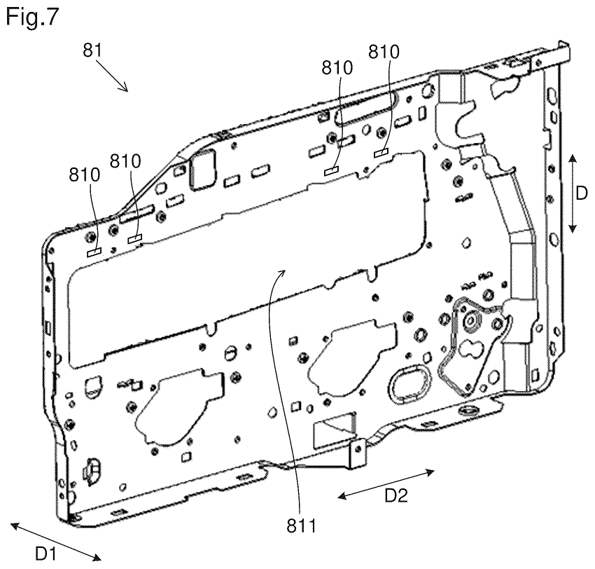

In the following description, for distinction, the side plate 81 is referred to as the right side plate 81 and the side plate 82 is referred to as the left side plate 82. The right side plate 81 corresponds to “one-side plate. ” The right side plate 81 alone is illustrated in FIG. 7. In addition, in the following description, for convenience, the region between the right and left side plates 81 and 82 along the left-right direction D1 is occasionally referred to as the side plate-to-side plate region.

Note that, in the following description, “outward along the left-right direction D1” means a direction from the middle of the side plate-to-side plate region between the right and left side plates 81 and 82 along the left-right direction D1 toward one side (right side) or the other side (left side) along the left-right direction D1. For example, “outward of the right side plate 81 along the left-right direction D1” means the right side of the right side plate 81. “Outward of the left side plate 82 along the left-right direction D1” means the left side of the left side plate 82.

On the other hand, in the following description, “inward along the left-right direction D1” means a direction from one side (right side) or the other side (left side) along the left-right direction D1 toward the middle of the side plate-to-side plate region along the left-right direction D1. For example, “inward of the right side plate 81 along the left-right direction D1” means the left side of the right side plate 81. “Inward of the left side plate 82 along the left-right direction D1”means the right side of the left side plate 82.

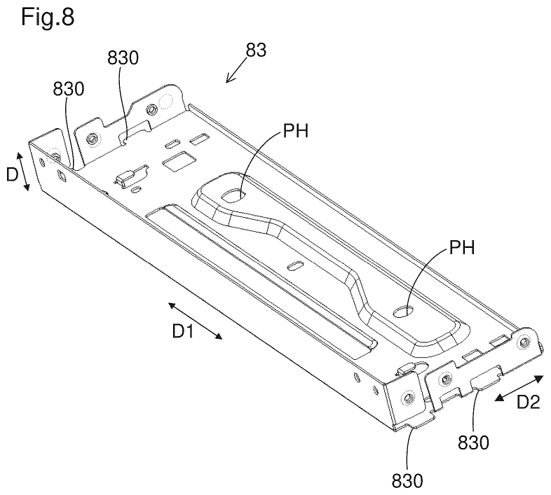

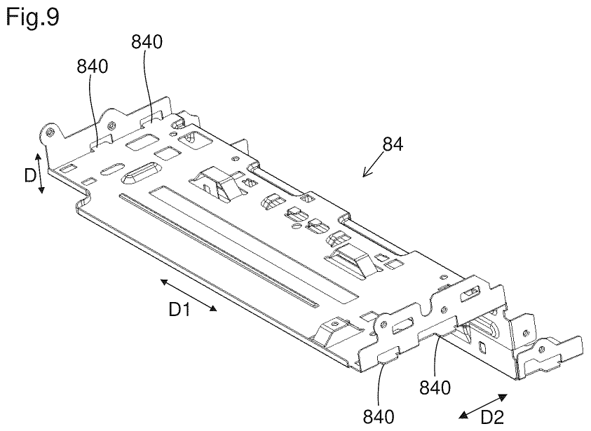

The body frame 8 includes a front stay 83 and a rear stay 84. The front and rear stays 83 and 84 each correspond a “stay.” The front stay 83 alone is illustrated in FIG. 8 and the rear stay 84 alone is illustrated in FIG. 9.

The front and rear stays 83 and 84 are disposed in the side plate-to-side plate region between the right and left side plates 81 and 82. The fronts stay 83 is disposed at one side (front side) in the side plate-to-side plate region along the front-rear direction D2. The rear stay 84 is disposed, with respect to the front stay 83, at the other side (rear side) in the side plate-to-side plate region along the front-rear direction D2.

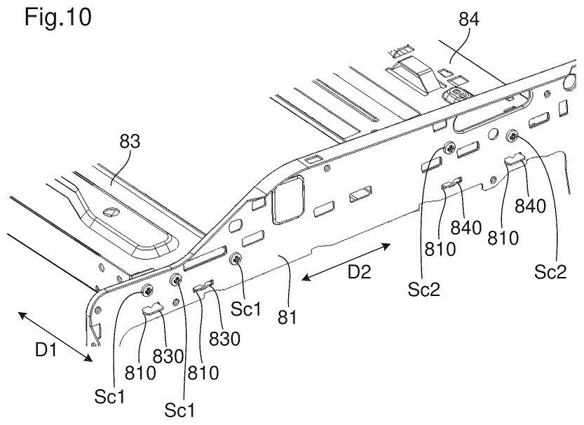

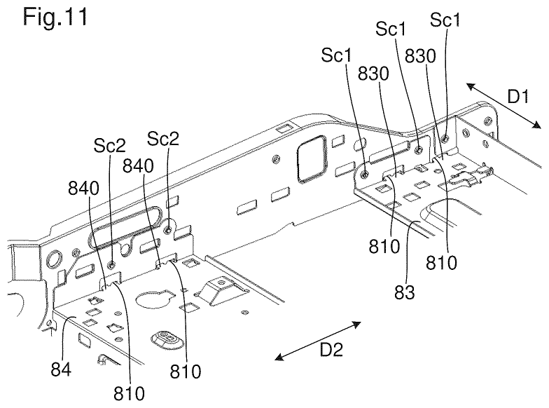

The front stay 83 is fastened to the right and left side plates 81 and 82 with fastening members Sc1 such as screws (see FIGS. 10 and 11). Of the front stay 83, a right end part is fastened to the right side plate 81 with screws and a left end part is fastened to the left side plate 82 with screws.

Likewise, the rear stay 84 is fastened to the right and left side plates 81 and 82 with fastening members Sc2 such as screws (see FIGS. 10 and 11). Of the rear stay 84, a right end part is fastened to the right side plate 81 with screws and a left end part is fastened to the left side plate 82 with screws.

FIGS. 10 and 11 show a specific structure for fastening the front and rear stays 83 and 84 to the right side plate 81. No illustration will be given for a specific structure for fastening the front and rear stays 83 and 84 to the left side plate 82.

The front and rear stays 83 and 84 and the right side plate 81 are positioned with respect to each other. The front and rear stays 83 and 84 and the left side plate 82 are positioned with respect to each other.

Specifically, the front stay 83 has, on each of both end parts of it along the left-right direction D1, two positioning projections 830, that projects outward along the left-right direction D1 from the stay body (no reference sign assigned) of the front stay 83. The rear stay 84 has, on each of both end parts of it along the left-right direction D1, two positioning projections 840, that project outward along the left-right direction D1 from the stay body (no reference sign assigned) of the rear stay 84.

On the other hand, the right side plate 81 has four positioning holes 810 that penetrate it along the left-right direction D1 (i.e., the plate thickness direction of the right side plate 81). Of the four positioning holes 810, two are disposed at positions overlapping with the front stay 83 along the left-right direction D1 and the other two are disposed at positions overlapping with the rear stay 84 along the left-right direction D1.

The left side plate 82 has four positioning holes 820 that penetrate it along the left-right direction D1 (i.e., the plate thickness direction of the left side plate 82). Of the four positioning holes 820, two are disposed at positions overlapping with the front stay 83 along the left-right direction D1 and the other two are disposed at positions overlapping with the rear stay 84 along the left-right direction D1.

Thus, inserting the positioning projections 830 on the front stay 83 respectively through the two positioning holes 810 in the right side plate 81 positions the right side plate 81 and the front stay 83 with respect to each other. Inserting the positioning projections 830 on the front stay 83 respectively through the two positioning holes 820 in the left side plate 82 positions the left side plate 82 and the front stay 83 with respect to each other.

Likewise, inserting the positioning projections 840 of the rear stay 84 respectively through the two positioning holes 810 in the right side plate 81 positions the right side plate 81 and the rear stay 84 with respect to each other. Inserting the positioning projections 840 on the rear stay 84 respectively through the two positioning holes 820 in the left side plate 82 positions the left side plate 82 and the rear stay 84 with respect to each other.

Note that the body frame 8 further includes an intermediate frame MF. The intermediate frame MF is disposed in the side plate-to-side plate region between the right and left side plates 81 and 82. The intermediate frame MF is disposed, in the side plate-to-side plate region, below the front and rear stays 83 and 84 are disposed. Of the intermediate frame MF, a right end part is fastened to the right side plate 81 and a left end part is fastened to the left side plate 82.

### Fitting of Different Units to Body Frame

Starting with the state in FIG. 6, that is, after the body frame 8 is assembled, the body frame 8 is fitted with the exposure unit 2, the drum units 1 (four of them), and the development units 3 (four of them) in this order. Note that there is no particular limitation on the order of the fitting of the units to the body frame 8.

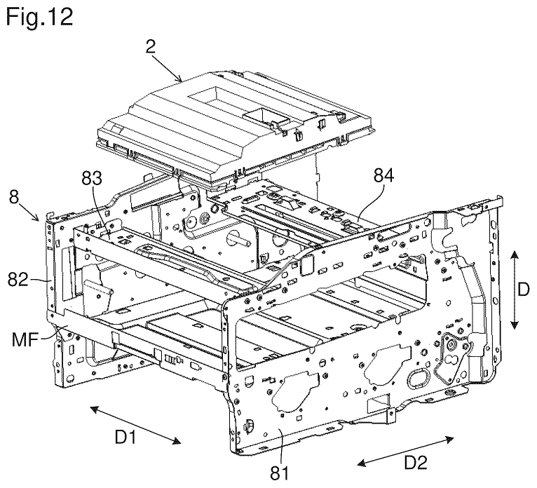

As shown in FIG. 12, the exposure unit 2 is inserted from above into the side plate-to-side plate region between the right and left side plates 81 and 82 to be disposed there. The exposure unit 2 is attached from above with respect to the front and rear stays 83 and 84. In other words, the exposure unit 2 is mounted on the front and rear stays 83 and 84. This positions the exposure unit 2 along the top-bottom direction D.

By being attached to the front stay 83, the exposure unit 2 is positioned along the left-right direction D1 as well as along the front-rear direction D2. Specifically, the front stay 83 has two positioning holes PH (see FIG. 8) that penetrate it along the top-bottom direction D. The two positioning holes PH are disposed at an interval from each other along the left-right direction D1. The center positions of the two positioning holes PH along the front-rear direction D2 coincide. While one positioning hole PH is a circular hole, the other positioning hole PH is an oval hole of which the longitudinal direction aligns with the left-right direction D1.

The exposure unit 2 has two positioning pins (not shown) projecting downward. With the exposure unit 2 fitted to the front stay 83, one of the positioning pins of the exposure unit 2 is inserted in one of the positioning holes PH (the circular hole) and the other positioning pin of the exposure unit 2 is inserted in the other positioning hole PH (the oval hole). This positions the exposure unit 2.

The drum units 1 are disposed in the side plate-to-side plate region between the right and left side plates 81 and 82. The region where the drum units 1 are disposed is below where the front and rear stays 83 and 84 are disposed and above where the intermediate frame MF is disposed. In other words, the drum units 1 are disposed below the exposure unit 2 is disposed.

To dispose the drum units 1 below the exposure unit 2, the right side plate 81 is provided with an opening 811 (see FIG. 7). The opening 811 penetrates the right side plate 81 along the left-right direction D1 (i.e., the plate thickness direction of the right side plate 81).

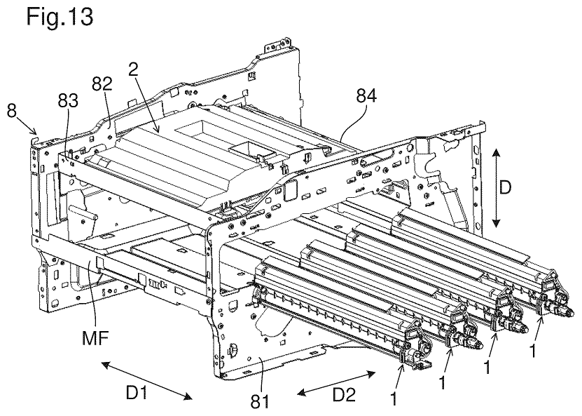

As shown in FIG. 13, the drum units 1 are inserted from outward (the right side) of the right side plate 81 along the left-right direction D1 through the opening 811 into the side plate-to-side plate region between the right and left side plates 81 and 82. This disposes the drum units 1 in the side plate-to-side plate region. In other words, the drum units 1 can be disposed below the exposure unit 2.

Likewise, the development units 3 are disposed below the exposure unit 2. That is, the development units 3 are disposed in the side plate-to-side plate region between the right and left side plates 81 and 82.

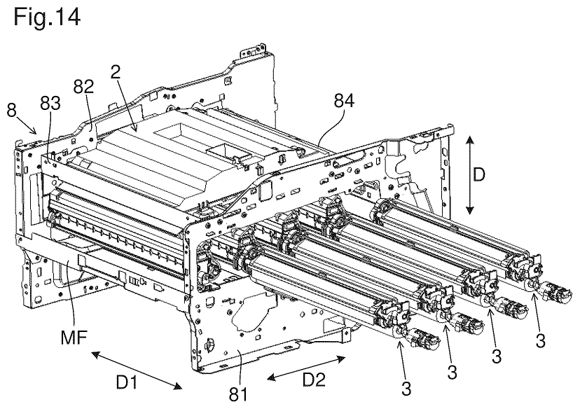

As shown in FIG. 14, the development units 3 are inserted from outward (the right side) of the right side plate 81 along the left-right direction D1 through the opening 811 into the side plate-to-side plate region between the right and left side plates 81 and 82. This disposes the development units 3 in the side plate-to-side plate region. In other words, the development units 3 can be disposed below the exposure unit 2.

Note that, outward (left side) of the left side plate 82 along the left-right direction D1, a driving mechanism (not shown) is provided that rotates different rotary members such as the photosensitive drums 11 and the development rollers 31. The driving mechanism includes a motor that is connected to the different rotary members. The driving mechanism is connected to the drum units 1 to transmit a driving force to the drum units 1. The driving mechanism is also connected to the development units 3 to transmit a driving force to the development units 3.

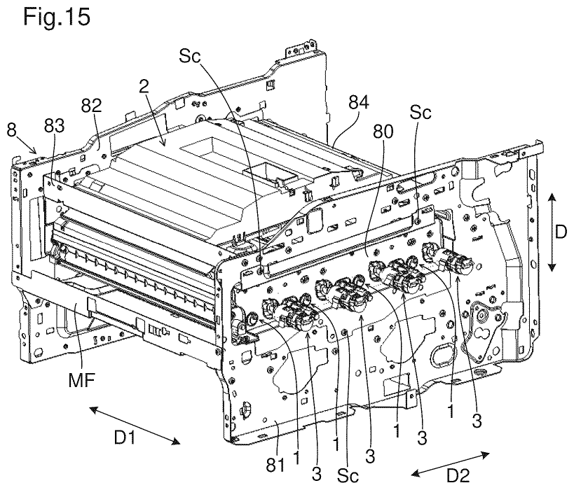

Here, as shown in FIGS. 15 to 18, the body frame 8 includes a fitted plate 80. The fitted plate 80 is fitted to the right side plate 81 from outward (right side) of it along the left-right direction D1. The fitted plate 80 is fitted to the right side plate 81 with fastening members Sc such as screws. The fitted plate 80, when fitted to the right side plate 81, covers the opening 811 from outward (right side) of it along the left-right direction D1.

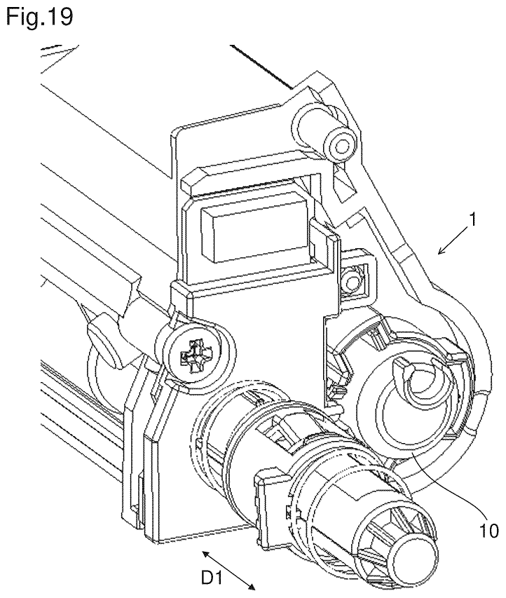

The drum units 1 are fitted to, in a state positioned with respect to, the fitted plate 80. Specifically, the fitted plate 80 has four drum positioning holes 801 corresponding to the four drum units 1. The drum positioning holes 801 penetrate the fitted plate 80 along the left-right direction D1 (i.e., the plate thickness direction of the fitted plate 80). The drum units 1 have drum positioning portions 10 (see FIG. 19) respectively that can be fitted in the corresponding drum positioning holes 801. Inserting the drum positioning portions 10 into the corresponding drum positioning holes 801 positions the drum units 1 on the fitted plate 80.

Likewise, the development units 3 are fitted to, in a state positioned with respect to, the fitted plate 80. Specifically, the fitted plate 80 has four development positioning holes 803 corresponding to the four development units 3. The development positioning holes 803 penetrate the fitted plate 80 along the left-right direction D1 (i.e., the plate thickness direction of the fitted plate 80). The development units 3 have development positioning portions 30 that can be fitted in the corresponding development positioning holes 803. Inserting the development positioning portions 30 into the corresponding development positioning holes 803 positions the development units 3 on the fitted plate 80.

The fitted plate 80 is fitted to the right side plate 81. Here, the positioning of the fitted plate 80 is achieved between the fitted plate 80 and the front stay 83 and between the fitted plate 80 and the rear stay 84. Specifically, the fitted plate 80 has two positioning holes 800 that penetrate it along the left-right direction D1. One positioning hole 800 is disposed at a position overlapping with the front stay 83 along the left-right direction D1. The other positioning hole 800 is disposed at a position overlapping with the rear stay 84 along the left-right direction D1.

One of the two positioning projections 830 provided on the front stay 83 at its right side penetrates the positioning hole 810 in the right side plate 81 and projects from the right side plate 81 outward (right side) of it along the left-right direction D1. One of the two positioning projections 840 provided on the rear stay 84 at its right side penetrates the positioning hole 810 in the right side plate 81 and projects from the right side plate 81 outward (right side) of it along the left-right direction D1.

Into one positioning hole 800 in the fitted plate 80, the positioning projection 830 on the front stay 83 is inserted that projects via the positioning hole 810 outward (right side) of the right side plate 81 along the left-right direction D1. Into the other positioning hole 800 in the fitted plate 80, the positioning projection 840 on the rear stay 84 is inserted that projects via the positioning hole 810 outward (right side) of the right side plate 81 along the left-right direction D1. This positions the fitted plate 80 with respect to both the front and rear stays 83 and 84.

In the embodiment, the exposure unit 2 is fitted to, in a state positioned with respect to, both the front and rear stays 83 and 84. The drum units 1 are fitted to, in a state positioned with respect to, the fitted plate 80.

In this configuration, if the front and rear stays 83 and 84 are positioned with respect to the right side plate 81 and the fitted plate 80 is positioned with respect to the right side plate 81, tolerances tend to accumulate, and this leads to a large positional displacement between the drum units 1 and the exposure unit 2. For example, a large displacement between the drum units 1 and the exposure unit 2 can cause a displacement of the position at which the electrostatic latent images start to be formed on the photosensitive drums 11, and this can lead to an image defect.

In contrast, in the embodiment, the fitted plate 80 is positioned, with no reference to the right side plate 81, with respect to each of the front and rear stays 83 and 84. This helps reduce a displacement between the drum units 1 and the exposure unit 2. In other words, it is possible to accurately mount the drum units 1 in the body of the image forming apparatus 100.

Likewise, in the embodiment, the development units 3 are fitted to, in a state positioned with respect to, the fitted plate 80. This helps reduce a displacement between the development units 3 and the exposure unit 2.

Here, in the embodiment, the positioning projection 830 on the front stay 83 is inserted through the positioning hole 810 in the right side plate 81 into the positioning hole 800 in the fitted plate 80. Likewise, the positioning projection 840 on the rear stay 84 is inserted through the positioning hole 810 in the right side plate 81 into the positioning hole 800 in the fitted plate 80. That is, the positioning projection 830 on the front stay 83 is used for positioning with respect to both the right side plate 81 and the fitted plate 80. The positioning projection 840 on the rear stay 84 is used for positioning with respect to both the right side plate 81 and the fitted plate 80.

This eliminates the need, in the configuration where the fitted plate 80 is positioned with respect to each of the front and rear stays 83 and 84, to provide each of these with a positioning portion (e.g., a positioning projection) for positioning the fitted plate 80. This helps avoid complicating in the structures of the front and rear stays 83 and 84.

In addition, according to the embodiment, the fitted plate 80 is fastened with the fastening members Sc to the right side plate 81 on both sides parts of it across the opening 811. In other words, the fitted plate 80 is fastened with the fastening members Sc to the right side plate 81 on a part of it around the edge of the opening 811. On the right side plate 81, at two places above the opening 811 and at one place below it, that is, at three places in total, the fitted plate 80 is fastened to the right side plate 81 with the fastening members Sc. This ensures the mechanical strength of the right side plate 81 even with the opening 811 formed in it.

The embodiment disclosed herein should be understood to be in every aspect illustrative and not restrictive. The scope of the present disclosure is set forth in the appended claims, and not in the above description of the embodiment. The scope of the present invention encompasses any modifications within a scope equivalent in significance to the claims.

What is claimed is:

1. An image forming apparatus comprising:
a body frame including a pair of side plates facing each other along a predetermined direction and a stay disposed between the pair of side plates along the predetermined direction;
a drum unit disposed between the pair of side plates along the predetermined direction, the drum unit including a photosensitive drum; and
an exposure unit disposed between the pair of side plates along the predetermined direction, the exposure unit shining light to an outer circumferential surface of the photosensitive drum to form an electrostatic latent image on the outer circumferential surface of the photosensitive drum,
wherein
one side plate of the pair of side plates has an opening penetrating therethrough along the predetermined direction,
the drum unit is disposed between the pair of side plates along the predetermined direction by being inserted from outward of the one side plate along the predetermined direction through the opening to between the pair of side plates along the predetermined direction,
the body frame further includes a fitted plate that covers the opening from outward along the predetermined direction,
the drum unit is fitted to, in a state positioned with respect to, the fitted plate,
the exposure unit is fitted to, in a state positioned with respect to, the stay,
the one side plate has a through hole penetrating therethrough along the predetermined direction,
the stay has a positioning projection that projects outward along the predetermined direction from the one side plate via the through hole,
the fitted plate has a positioning hole penetrating therethrough along the predetermined direction, and
inserting the positioning projection that projects outward along the predetermined direction from the one side plate through the through hole into the positioning hole positions the stay and the fitted plate with respect to each other.

2. The image forming apparatus according to claim 1 further comprising:
a development unit disposed between the pair of side plates along the predetermined direction, the development unit feeding toner to the outer circumferential surface of the photosensitive drum to develop the electrostatic latent image into a toner image,
wherein
the development unit is fitted to, in a state positioned with respect to, the fitted plate.

3. The image forming apparatus according to claim 1, wherein
inserting the positioning projection into the through hole positions the one side plate and the stay with respect to each other.

4. The image forming apparatus according to claim 1, wherein
the fitted plate is fastened with a fastening member to the one side plate on both sides parts thereof across the opening.
